(19) United States
(12) Patent Application Publication
(10) Pub. No.: US 2024/0070284 A1
(43) Pub. Date: Feb. 29, 2024

(54) SECURE BOOT PROCEDURE

(71) Applicant: Micron Technology, Inc., Boise, ID (US)

(72) Inventors: Alessandro Orlando, Milano (IT); Niccolò Izzo, Vignate (IT); Angelo Alberto Rovelli, Agrate Brianza (IT); Danilo Caraccio, Milano (IT); Federica Cresci, Milan (IT); Craig A. Jones, Plano, TX (US)

(21) Appl. No.: 18/237,247

(22) Filed: Aug. 23, 2023

Related U.S. Application Data
(60) Provisional application No. 63/400,747, filed on Aug. 24, 2022.

(51) Int. Cl. G06F 21/57

(52) U.S. Cl. CPC G06F 21/575; G06F 21/572; G06F 2221/033

(57) ABSTRACT

Protection for a secure boot procedure can be provided in addition to cryptographic verification of boot firmware associated with the boot procedure. While the boot firmware is being verified, an open sub-system can be placed into a halt state, during which the open sub-system is prevented from performing the boot procedure. The open sub-system can be subsequently placed into a resume state to further perform the boot procedure when the boot firmware is verified. The open sub-system is still prevented from performing the boot procedure even if the boot firmware is verified unless the open sub-system is placed into the resume state again.

### PRIORITY INFORMATION

This application claims the benefit of U.S. Provisional Application No. 63/400,747, filed on Aug. 24, 2022, the contents of which are incorporated herein by reference.

### TECHNICAL FIELD

The present disclosure relates generally to semiconductor memory and methods, and more particularly, to apparatuses, systems, and methods for secure boot procedure.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, ferroelectric random access memory (FeRAM), and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

FIG. 1 is a functional block diagram of a computing system for performing a secure boot procedure in accordance with a number of embodiments of the present disclosure.

FIG. 2 is a functional block diagram of a management unit including an open sub-system, a secure sub-system, and a non-volatile memory configured to perform a secure boot procedure in accordance with a number of embodiments of the present disclosure.

FIG. 3 is a sequence diagram illustrating the performance of a secure boot procedure in accordance with a number of embodiments of the present disclosure.

FIG. 4 is a flow diagram of a method for performing a secure boot procedure in accordance with a number of embodiments of the present disclosure.

FIG. 5 is a flow diagram of a method for performing a secure boot procedure in accordance with a number of embodiments of the present disclosure.

### DETAILED DESCRIPTION

Systems, apparatuses, and methods related to secure boot procedure are described. A boot procedure initiates responsive to start-up of a computing system, such as when a computing system is powered-up or restarted. During the boot procedure, integrated boot programs (e.g., firmware) built into the computing system are executed to initialize the computing system, run self-tests, and identify hardware/software resources of the computing system. Further, the boot programs may also perform operations to configure the hardware/software resources to further load and run an operating system for the computing system.

Boot programs (e.g., code) may be required to be verified prior to being executed during the boot procedure. Due to hardware/software resources of a secure component dedicated to the verification process being often limited, operation of the secure component may not be entirely independent of the other components of the computing system that may be relatively easily accessible by attackers. This can be exploited by attackers who can choose to take over control of the other components, instead of the secure component, to eventually take over control of the computing system during runtime of the boot procedure. This control can be obtained by the attackers when, for example, the attackers obtain secure boot code (which may have unknown vulnerability) and/or access to a serial peripheral interface (SPI) NOR package (where the boot programs are stored). When the control of the computing system is undesirably obtained by the attackers, the attackers can instruct the computing system to bypass (e.g., ignore) the verification process and instruct the computing system to load and execute firmware (e.g., malicious firmware) implemented by the attacker. Runtime attacks can be performed at various times during system operation, which can include during secure boot procedure execution, and/or at various locations within the system, which can include at locations considered the Chain of Trust (CoT) or the Root of Trust (RoT). As used herein, the term “Chain of Trust (CoT)” refers to components of hardware (e.g., a computing system) and/or software that are ensured to have a certain level of trust (e.g., security) by requiring each component to be validated from the end point up to the root of trust (e.g., certificate). As used herein, the term “Root of Trust (RoT)” is a source for security of hardware or software. For example, the RoT can include a cryptographic key (one or more keys) that can be used for cryptographic operations (e.g., verifications) and a secure boot procedure of the hardware or software.

Embodiments described herein provides additional protection against runtime attacks that further ensures that a boot procedure isn't further performed (e.g., executed) unless the verification process is performed. In a number of embodiments, an open sub-system (that loads/executes a substantial portion of the boot firmware) can include a register that is accessible only by a secure sub-system (that verifies the boot firmware loaded to the open sub-system) and that can place the open sub-system into a particular operating state, in which the open sub-system is prevented from further performance of the boot procedure (e.g., prevented from executing firmware associated with the boot procedure). By maintaining the particular operating state until the verification process is successfully completed, the secure sub-system can ensure that no other (e.g., unverified) firmware is executed at the open sub-system even if the attackers instruct the open sub-system to bypass the verification process.

In some embodiments, the memory system can be a compute express link (CXL) compliant memory system. The host interface can be managed with CXL protocols and be coupled to the host via an interface configured for a peripheral component interconnect express (PCIe) protocol. CXL is a high-speed central processing unit (CPU)-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall system cost. CXL is designed to be an industry open standard interface for high-speed communications, as accelerators are increasingly used to complement CPUs in support of emerging applications such as artificial intelligence and machine learning. CXL technology is built on the PCIe infrastructure, leveraging PCIe physical and electrical interfaces to provide advanced protocol in areas such as input/output (I/O) protocol, memory protocol (e.g., initially allowing a host to share memory with an accelerator), and coherency interface.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. It is to be understood that data can be transmitted, received, or exchanged by electronic signals (e.g., current, voltage, etc.) and that the phrase “signal indicative of [data]” represents the data itself being transmitted, received, or exchanged in a physical medium.

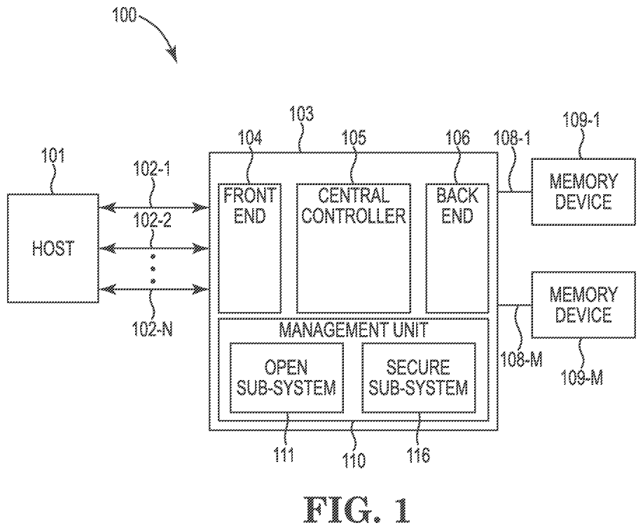

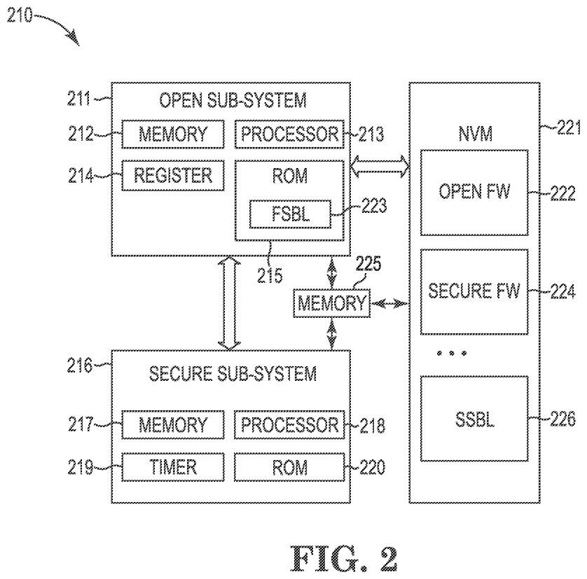

The figures herein follow a numbering convention in which the first digit or digits correspond to the drawing figure number and the remaining digits identify an element or component in the drawing. Similar elements or components between different figures may be identified by the use of similar digits. For example, 110 may reference element “10” in FIG. 1, and a similar element may be referenced as 210 in FIG. 2. Analogous elements within a Figure may be referenced with a hyphen and extra numeral or letter. See, for example, elements 102-1, 102-2, 102-M in FIG. 1. Such analogous elements may be generally referenced without the hyphen and extra numeral or letter. For example, elements 102-1, 102-2, 102-M may be collectively referenced as 102. As used herein, the designators “M” and “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a functional block diagram of a computing system 100 for performing a secure boot procedure including a memory controller 103 in accordance with a number of embodiments of the present disclosure. The memory controller 103 can include a front end portion 104, a central controller portion 105, and a back end portion 106. The computing system 100 can include a host 101 and memory devices 109-1, . . . , 109-N coupled to the memory controller 103.

The front end portion 104 includes an interface and interface management circuitry to couple the memory controller 103 to the host 101 through input/output (I/O) lanes 102-1, 102-2, . . . , 102-M and circuitry to manage the I/O lanes 102. There can be any quantity of I/O lanes 102, such as eight, sixteen, or another quantity of I/O lanes 102. In some embodiments, the I/O lanes 102 can be configured as a single port. In at least one embodiment, the interface between the memory controller 103 and the host 101 can be a PCIe physical and electrical interface operated according to a CXL protocol.

The central controller portion 105 can include and/or be referred to as data management circuitry. The central controller portion 105 can control, in response to receiving a request from the host 101, performance of a memory operation. Examples of the memory operation include a read operation to read data from a memory device 109 or a write operation to write data to a memory device 109.

The central controller portion 105 can further provide protection over data stored in the memory devices 109, such as a chip kill protection, in which the memory system can work properly even if a constituent chip, such as a memory device 109, is damaged; thereby, avoiding a situation of one of the chips being a single point of failure (SPOF) of the memory system. The chip kill protection that can be provided through various error correction code (ECC) schemes including a “Redundant Array of Independent Disks” (RAID) scheme, a low-power chip kill (LPCK) scheme, etc., which allow data recovery of the damaged chip by reading all of the constituent chips (e.g., the memory devices 109) of the computing system 100. The chip kill protection against any single memory device 109 (chip) failure and/or multi-bit error from any portion of a single memory chip can be implemented collectively across subsets of the memory devices 109 or across all of the memory devices 109.

The back end portion 106 can include a media controller and a physical (PHY) layer that couples the memory controller 103 to the memory devices 109. As used herein, the term “PHY layer” generally refers to the physical layer in the Open Systems Interconnection (OSI) model of a computing system. The PHY layer may be the first (e.g., lowest) layer of the OSI model and can be used transfer data over a physical data transmission medium. In some embodiments, the physical data transmission medium can include channels 108-1, . . . , 108-N. The channels 108 can include various types of data buses, such as a sixteen-pin data bus and a two-pin data mask inversion (DMI) bus, among other possible buses.

An example of the memory devices 109 is dynamic random access memory (DRAM) operated according to a protocol such as low-power double data rate (LPDDRx), which may be referred to herein as LPDDRx DRAM devices, LPDDRx memory, etc. The “x” in LPDDRx refers to any of a number of generations of the protocol (e.g., LPDDR5). In at least one embodiment, at least one of the memory devices 109-1 is operated as an LPDDRx DRAM device with low-power features enabled and at least one of the memory devices 109-N is operated an LPDDRx DRAM device with at least one low-power feature disabled. In some embodiments, although the memory devices 109 are LPDDRx memory devices, the memory devices 109 do not include circuitry configured to provide low-power functionality for the memory devices 109 such as a dynamic voltage frequency scaling core (DVFSC), a sub-threshold current reduce circuit (SCRC), or other low-power functionality providing circuitry. Providing the LPDDRx memory devices 109 without such circuitry can advantageously reduce the cost, size, and/or complexity of the LPDDRx memory devices 109. By way of example, an LPDDRx memory device 109 with reduced low-power functionality providing circuitry can be used for applications other than mobile applications (e.g., if the memory is not intended to be used in a mobile application, some or all low-power functionality may be sacrificed for a reduction in the cost of producing the memory).

Another example of the memory devices 109 is non-volatile memory, such as ferroelectric random access memory (FeRAM) among others. The memory controller 103 can manage a DRAM memory device 109 and a FeRAM memory device 109. Further, in some embodiments, instead of managing both a DRAM memory device 109 and a FeRAM memory device 109, the memory controller 103 can be configured to manage either just volatile memory devices, such as DRAM memory devices 109, or just FeRAM memory devices 109.

In some embodiments, the memory controller 103 can include a management unit 110 to initialize, configure, and/or monitor characteristics of the memory controller 103. Further, the management unit 110 can be used to execute non-memory functions. Such examples can include logging, error reporting, support of discovery by the host, security protocols management, security functions, etc. In some embodiments, the management unit 110 can include an I/O bus to manage out-of-band data and/or commands, a management unit controller to execute one or more instructions associated with initializing, configuring, and/or monitoring the characteristics of the memory controller, and a management unit memory to store data associated with initializing, configuring, and/or monitoring the characteristics of the memory controller 103. As used herein, the term “out-of-band data and/or commands” generally refers to data and/or commands transferred through a transmission medium that is different from the main transmission medium of a network. For example, out-of-band data and/or commands can be data and/or commands transferred to a network using a different transmission medium than the transmission medium used to transfer data within the network.

Further, as illustrated in FIG. 1, the management unit 110 can include an open sub-system 111 and a secure sub-system 116 that are configured to perform a boot procedure in response to a boot request (e.g., from host 101). The open sub-system 111 and the secure sub-system 116 can operate in conjunction with various firmware interfaces, such as Unified Extensible Firmware Interface (UEFI), Advanced Configuration and Power Interface (ACPI), Basic input Output System (BIOS) interfaces, and/or custom Application Programming Interfaces (APIs), among others.

The open sub-system 111 can be configured for storing/loading (e.g., from a non-volatile memory 221 illustrated in FIG. 2) boot firmware and execute the boot firmware dedicated to initializing hardware resources, loading drivers for the resources, and/or performing operations as defined for the boot procedure. As used herein, the term “boot firmware” is computer-executable codes that controls a computing system from the time that it is turned on until the primary operating system has taken control of the machine. For example, the boot firmware can be executed to load and/or verify other boot firmware until the primary operating system has taken control of the computing system 100.

The secure sub-system 116 can be configured for storing computer-executable instructions (e.g., codes) to cryptographically verify boot firmware to be loaded to/executed at the open sub-system 111 and/or the secure sub-system 116. In some embodiments, the secure sub-system 116 can further load/execute boot firmware dedicated for verifying the other boot firmware loaded from the memory 221. The secure sub-system 116 can perform a verification process on the boot firmware according to various cryptographic algorithms, such as Rivest-Shamir-Adleman (RSA), Elliptic-curve cryptography such as Elliptic Curve Digital Signature Algorithm (ECDSA), Elliptic-curve Diffie-Hellman (ECDH), Edwards-curve Digital Signature Algorithm (EdDSA), Paillier cryptosystem, Cramer-Shoup cryptosystem, YAK authenticated key agreement protocol, Advanced Encryption Standard (AES), Twofish algorithm, Blowfish algorithm, International Data Encryption Algorithm (IDEA), MD5 (MD5 message-digest algorithm), Hash-based message authentication code (HMAC), or any combination thereof.

FIG. 2 is a functional block diagram of a portion of a system that includes an open sub-system 211, a secure sub-system 216, and a non-volatile memory 221 configured to perform a secure boot procedure in accordance with a number of embodiments of the present disclosure. In this example, the open sub-system 211 and the secure sub-system 216 are part of a management unit 210, which can be a management unit such as 110 shown in FIG. 1; however, embodiments are not so limited. For example, one or both of the sub-systems 211 and 216 may not be located on a controller of a memory system.

As illustrated in FIG. 2, the open sub-system 211 can include a memory 212, a processor 213, a register 214, and a read-only memory (ROM) 215. The open sub-system 211 can be accessed by another approved sub-system, such as the secure sub-system 216. In some embodiments, the processor 213 can include a CPU.

The ROM 215 is configured for storing instructions (immutable codes), such as a first stage bootloader (FSBL) 223, to execute a boot procedure. The management unit 210 when shipped (e.g., as part of the memory controller 103 illustrated in FIG. 1) from a manufacturer to a customer, such as an end user, organization, or service provide, may have the FSBL 223 already stored in the ROM 215. The FSBL (e.g., the FSBL 223) is ROM-based boot firmware to initially load other boot firmware to the open sub-system 211 and/or the secure sub-system 216 during the boot procedure. As used herein, the term “boot procedure” refers to a process of initializing a computing system from a halted and/or powered-down condition. When the FSBL 223 is executed, the FSBL 223 loads the other boot firmware (e.g., cause the other boot firmware to be loaded), such as second stage boot loader (e.g., SSBL 226), to the memory 212. In some embodiments, the boot procedure can be triggered by a reset or a power-cycle event of the management unit 110, for example. The management unit 110 can be capable of resetting itself without an external input.

The memory 212 can be configured for storing boot firmware loaded from, for example, the non-volatile memory 221, such as open firmware 222 and/or SSBL 226. Although embodiments are not so limited, the memory 212 can be a volatile memory.

A binary value of the register 214 can be used to indicate which one of two states (e.g., “1” or “0”), for example, the open sub-system 211 is in during a boot procedure. As an example, a first state (e.g., indicated by a binary “1”) can be referred to as a “resume” state of the open sub-system 211 and can correspond to a state in which the open sub-system 211 is allowed to execute (or resume execution of) the boot procedure, which can include loading and/or executing boot firmware from the non-volatile memory 221 and/or the memory 212, 217. On the other hand, a second state (e.g., indicated by a binary “0”) can be referred to as a “halt” state of the open sub-system 211 and can correspond to state in which the open sub-system 211 is prevented from further performance/execution of the boot procedure. For example, the open sub-system 211 in the halt state is prevented from further executing bootloaders and/or firmware loaded to the memory 212. When the open sub-system 211 is placed into the halt state, the open sub-system 211 can save the current state (how far the boot procedure has been performed) so as to resume execution of the boot procedure from the point just prior to the open sub-system 211 being placed into the halt state, which can avoid the open sub-system 211 from having to restart the boot procedure. The register 214 can operate independently of the verification process. For example, even if the boot firmware is verified, the open sub-system 211 can still be prevented from further boot procedure execution unless the register is specifically set (e.g., to “1”) to indicate a resume of the boot procedure. The secure sub-system 216 can access and set the register 214, while the open sub-system 211 may not have such access to the register 214.

As illustrated in FIG. 2, the secure sub-system 216 can include a memory 217, a processor 218, a timer 219, and a ROM 220. In some embodiments, the processor 218 can include a CPU.

The secure sub-system 216 can be configured for storing cryptographic information (e.g., cryptographic keys, such as public and/or private keys) to be used in association with verifying firmware to be executed during a boot procedure. Access to the cryptographic information stored in the secure sub-system can be limited/restricted unless the access is from the secure sub-system itself. The cryptographic information can be stored in the memory 217 and/or the ROM 220.

The ROM 220 can be an immutable non-volatile memory that is configured for storing instructions (e.g., immutable codes) that can be executed by the processor 218 to initialize the secure sub-system 216 and/or to provide secure functionalities, such as cryptographically verifying the firmware (e.g., open firmware 222, the secure firmware 224, and/or SSBL 226) loaded to a memory (e.g., alliteratively referred to as “shared memory), the open sub-system 211, and/or the secure sub-system 216. In some embodiments, the open firmware 222 can be loaded to the memory 225, which can be accessible by both the open sub-system 211 and the secure sub-system 216.

The ROM 220 can further be configured for storing cryptographic information (e.g., cryptographic keys, such as public and/or private keys) to be used in association with verifying boot firmware (e.g., SSBL 226, open firmware 222, and/or secure firmware 224) to be executed during a boot procedure. In some embodiments, the cryptographic information can be provided by a manufacturer and be immutable throughout the usage of the secure sub-system in conjunction with the boot procedure.

The timer 219 can indicate whether a certain period of time has passed or not. The period of time can act as a time limit, by which the verification process to be performed by the secure sub-system 216 needs to be done. For example, the secure sub-system 216 can reset the timer 219 each time a verification request is received (e.g., from the open sub-system 211) such that the timer 219 starts counting the period of time from the moment it was reset. The boot firmware is said to be “verified” when it is verified within the time limit indicated by the timer 219. If the boot firmware is not verified within the time limit (e.g., not verified during the period of time counted by the timer 219), the verification process is considered to be failed and the secure sub-system 216 terminates the boot procedure and can log the failure, which can be reported to the host 101, for example. In some embodiments, the timer 219 can be a watchdog timer, which can include one pin to receive the reset (“kick”) signal from the secure sub-system 216 and another pin to output the timeout signal. The timer 219 can be controlled by the processor 218. For example, the processor 218 can execute instructions stored in the ROM 220 to reset, enable, and/or disable the timer 219.

As described herein, the non-volatile memory 221 is configured as a “boot sector” and configured for storing boot firmware. Although embodiments are not so limited, the boot firmware can include open firmware 222, secure firmware 224, and second stage bootloader (SSBL) 226. The SSBL 226 can be executed to load the secure firmware 224 to the memory 217 and the open firmware 222 to the memory 212 such that the secure firmware 224 and the open firmware 222 can be respectively/subsequently executed by the processors 213 and 218 of the open sub-system 211 and the secure sub-system 216. The secure firmware 224 is designed to ensure secure verification/execution of the open firmware 222. For example, the secure firmware 224, when executed, verifies the open firmware 222 prior to the open sub-system 211 executing the open firmware 222. As used herein, the term “open firmware” is a (e.g., proprietary or nonproprietary) boot firmware that is usable on various types of processors and buses to implement services, protocols, and functionalities required for the memory controller (e.g., the memory controller 100 as illustrated in FIG. 1) to operate as intended. In an example, where an operating system is needed to be loaded, the open firmware can further perform operations (e.g., read and/or write operations) to load and run the operating system for the computing system. In some embodiments, the non-volatile memory 221 can be a memory coupled to the management unit 110 via an SPI, for example.

As described further herein, the SSBL 226, the secure firmware 224, and the open firmware 222 can be loaded to the memory 225 or the secure sub-system 216 in a particular sequence during a boot procedure and can be executed once verified by the secure sub-system 216. For example, they can be loaded to the memory 212, 217, and/or 225 in an order of the SSBL 226, the secure firmware 224, and the open firmware 222.

A boot procedure can be a multi-stage procedure, in which respective firmware can be executed in each stage. The process of this multi-stage boot procedure can be further controlled by the secure sub-system 216. For example, prior to moving onto a next stage, the secure sub-system 216 can place the open sub-system 211 into a particular operating state (e.g., a halt state) to halt the boot procedure and prevent the open sub-system 211 from further execution of the boot procedure. When respective firmware to be executed at the next stage is verified by the secure sub-system 216, the secure sub-system 216 can place the open sub-system 211 back into a different operating state (e.g., a resume state) to allow the open sub-system 211 to perform (continue performance of) the boot procedure, which has been halted (e.g., placed into a halt state). However, if the firmware is not verified and/or failed to be verified, the secure sub-system 216 can terminate the boot procedure without switching the operating state of the open sub-system.

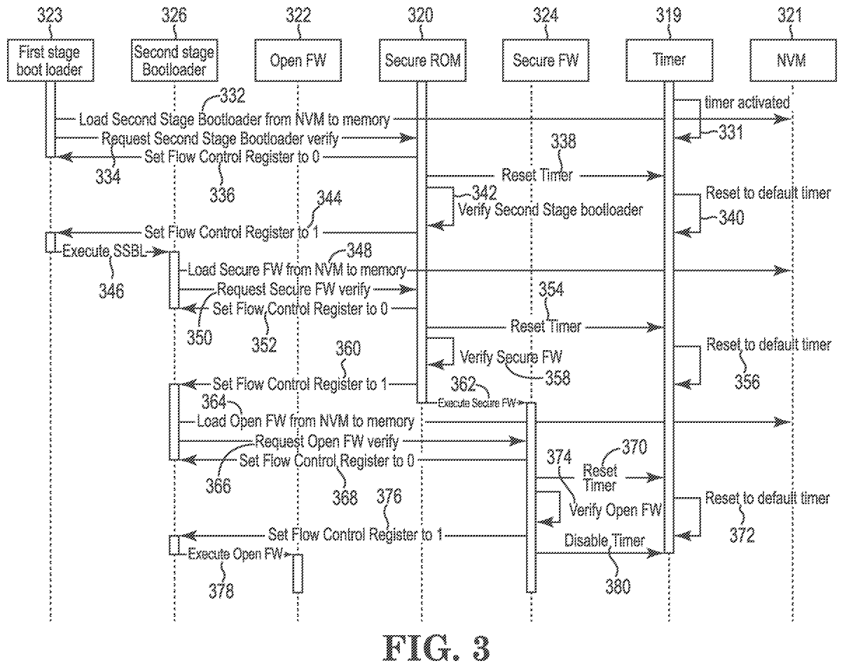

In a non-limiting example, an apparatus (e.g., the secure sub-system 216 illustrated in FIGS. 2 and 3) can include a processor (e.g., the processor 218 illustrated in FIG. 2). The apparatus further includes a memory (e.g., the ROM 220 illustrated in FIG. 2) coupled to the processor and configured for storing instructions executable by the processor. The instructions, when executed by the processor, can cause the processor to, in response to receipt of a request from a first sub-system (e.g., the open sub-system 211 and 311 illustrated in FIGS. 2 and 3) to verify firmware (e.g., the SSBL 226 and 326, secure firmware 224 and 324, and open firmware 222 and 322 illustrated in FIGS. 2 and 3, respectively) to be executed during a boot procedure, set a register (e.g., the register 214 illustrated in FIGS. 2 and 3, respectively) of the first sub-system to a first value to prevent the first sub-system from further performing the boot procedure. The instructions can further cause the processor to set the register of the first sub-system to allow the first sub-system to further perform the boot procedure responsive to verifying the firmware.

In some embodiments, the apparatus can further include a timer (e.g., the timer 219 and 319 illustrated in FIGS. 2 and 3) that indicates whether a particular period of time has passed. In this example, the instructions can cause the processor to set the register of the first sub-system to allow the first sub-system to further perform the boot procedure responsive to the firmware being verified within the particular period of time.

In some embodiments, the instructions can cause the processor to terminate the boot procedure responsive to the firmware not being verified within the particular period of time and/or a failure of the verification (despite that the particular period of time has not been expired yet). The instructions can further cause the processor to log a failure of the verification. In some embodiments, the instructions can cause the processor to reset the timer in response to setting the register of the first sub-system to the first value.

FIG. 3 is a sequence diagram 330 illustrating the performance of a secure boot procedure in accordance with a number of embodiments of the present disclosure. A first stage bootloader (FSBL) 323, a second stage bootloader (SSBL) 326, open firmware 322, ROM 320 (“Secure ROM” shown in FIG. 3), secure firmware 324, a timer 319, and a non-volatile memory (NVM) 321 are analogous to the FSBL 223, SSBL 226, open firmware 222, ROM 220, secure firmware 224, timer 219, and non-volatile memory 221 illustrated in FIG. 2, respectively.

At 331, the timer 319 is activated. In an example, the timer 319 is activated in response to initiation of a boot procedure (e.g., initiated at some point prior to 331). As shown at 332, the FSBL 323 (which can be stored within a ROM of an open sub-system such as shown in FIG. 2) is executed to load the SSBL from NVM 321 to memory (e.g., to local memory of the open sub-system, such as memory 212 shown in FIG. 2). As shown at 334, the FSBL 323 is also executed to request verification of the SSBL 326 by the secure sub-system (e.g., secure sub-system 216 shown in FIG. 2). For example, the SSBL 326 can be verified by execution of instructions stored in ROM 320 of the secure sub-system (e.g., ROM 220 of secure sub-system 216 shown in FIG. 2).

At 336, a signal to set a register (e.g., the register 214) to a first value (e.g., “0”) can be sent to the open sub-system 211 from the secure sub-system 216 to place the open sub-system 211 into a first state, in which the open sub-system 211 can be prevented from further performing the boot procedure and executing the SSBL 326. Further, at 338, the secure sub-system 216 can send a signal (e.g., a reset signal) to the timer 319 to reset the timer 319. At 340, the timer 319 can be reset in response to the reset signal to start counting a particular (e.g., predetermined) period of time.

At 342, the SSBL 326 can be verified. Once the SSBL 326 is verified, at 344, a signal to set the register to a second value (e.g., “1”) can be sent to the open sub-system 211 from the secure sub-system 216 to place the open sub-system 211 into a second state, in which the open sub-system 211 is again allowed to further perform the boot procedure and execute the SSBL 326.

At 346, the SSBL 326 can be executed in response to the open sub-system being placed into the second state. At 348, the secure firmware 324 can be loaded to the secure sub-system 216 (e.g., the memory 217 illustrated in FIG. 2) as a result of the execution of the SSBL 326. At 350, a request to verify the secure firmware 324 can be sent from the open sub-system 211 to the secure sub-system 216.

At 352, a signal to set the register to the first value (e.g., “0”) can be sent to the open sub-system 211 to place the open sub-system 211 into the first state, in which the open sub-system 211 can be prevented from further performing the boot procedure. Further, at 354, the secure sub-system 216 can send a signal (e.g., a reset signal) to the timer 319 to reset the timer 319. At 356, the timer 319 can be reset in response to the reset signal to start counting a particular period of time.

At 358, the secure firmware 324 can be verified. Once the secure firmware 324 is verified, a signal to set the register to the second value (e.g., “1”) can be sent to the open sub-system 211 from the secure sub-system 216 at 360 to place the open sub-system 211 into the second state, in which the open sub-system 211 is allowed again to further perform the boot procedure. Further, at 362, the secure firmware 324 can be executed (e.g., by the instructions stored in the ROM 320).

At 364, the SSBL 326 can be further executed to load the open firmware 322 to a shared memory (e.g., the memory 225) that is accessible by both open sub-system 211 and the secure sub-system 216. At 366, a request to verify the open firmware 322 can be sent to the secure sub-system 216 from the open sub-system 211.

At 368, a signal to set the register to the first value (e.g., “0”) can be sent from the secure sub-system 216 to the open sub-system 211 to place the open sub-system 211 into the first state, in which the open sub-system 211 can be prevented from further performing the boot procedure and executing the open firmware 322. Further, at 370, the secure sub-system 216 can send a signal (e.g., a reset signal) to the timer 319 to reset the timer 319. At 372, the timer 319 can be reset in response to the reset signal to start counting a particular period of time.

At 374, the open firmware 322 can be verified. Once the open firmware 322 is verified, at 376, a signal to set the register to the second value (e.g., “1”) can be sent to the open sub-system 211 to place the open sub-system 211 into a second state, in which the open sub-system 211 is allowed again to further perform the boot procedure and execute the open firmware 322 (e.g., executed from the shared memory 225). At 378, the open firmware 322 can be executed. Further, at 380, the timer 319 can be disabled.

In a non-limiting example, a system can include a first sub-system (e.g., the open sub-system 111 and 211 illustrated in FIGS. 1 and 2, respectively) including a memory (e.g., the ROM 215 illustrated in FIG. 2) configured for a first bootloader (e.g., the FSBL 223 and 323 illustrated in FIGS. 2 and 3) and a register (e.g., the register 214 illustrated in FIGS. 2 and 3, respectively). The system can further include a second sub-system (e.g., the secure sub-system 116 and 216 illustrated in FIGS. 1 and 2, respectively) communicatively coupled to the first sub-system.

The first sub-system can be configured to execute, in response to a request to initiate a boot procedure, the first bootloader to load a second bootloader (e.g., the SSBL 226 and 326 illustrated in FIGS. 2 and 3, respectively) to the first sub-system. The first sub-system can further send a request to verify the second bootloader to the second sub-system in response to the second bootloader being loaded to the first sub-system.

The second can be configured to, in response to receipt of the request to verify the second bootloader from the first sub-system, set the register to a first value to place the first sub-system into a first state to prevent the first sub-system from further performing the boot procedure and executing the second bootloader. The second sub-system can further set, in response to the second bootloader being verified, the register to a second value to place the first sub-system into a second state to allow the first sub-system to further perform the boot procedure and execute the second bootloader. In some embodiments, the first sub-system can be prevented from setting register.

In some embodiments, the second sub-system can be further configured to, subsequent to the register being set to the second value, receive a request to verify first firmware (secure firmware 224 and 324 in FIGS. 2 and 3) loaded by the second bootloader to the first sub-system. The second sub-system can be further configured to set the register to the first value to place the first sub-system into the first state, which prevents the first sub-system from preventing the first sub-system from further performing the boot procedure and executing the second bootloader. The second sub-system can be further configured to verify the first firmware responsive to the request and set the register to the second value responsive to the first firmware being verified to place the first sub-system back into the second state to allow the first sub-system to further perform the boot procedure and execute the second bootloader.

In some embodiments, the second sub-system further comprises a timer (e.g., the timer 219 and 319 illustrated in FIGS. 2 and 3) that indicates whether a particular period of time has passed. In this example, the second sub-system can be configured to set the register to the second value in response to the first firmware being verified within the particular period of time and reset the timer in response to receipt of the request to verify the first firmware.

Continuing with this example, the second sub-system can be configured to receive a request to verify second firmware (open firmware 222 and 322 illustrated in FIGS. 2 and 3) loaded by the second bootloader to the second sub-system. The second sub-system can further set the register to the first value to place the first sub-system into the first state to prevent the first sub-system from further performing the boot procedure and executing the second bootloader. The second sub-system can further verify the second firmware responsive to the request and set the register to the second value responsive to the second firmware being verified to place the first sub-system back into the second state to allow the first sub-system to further perform the boot procedure and execute the second firmware. In some embodiments, the second sub-system is configured to set the register to the second value in response to the second firmware being verified within the particular period of time and the second sub-system is configured to reset the timer in response to receipt of the request to verify the second firmware. Further, the second sub-system can be configured to disable the timer in response to the second firmware being verified.

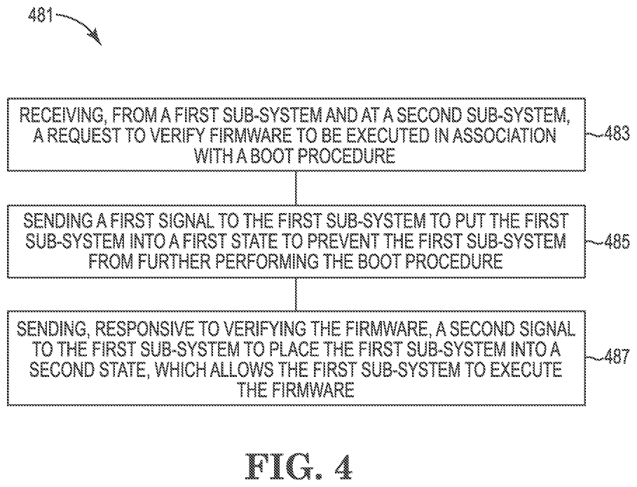

FIG. 4 is a flow diagram 481 of a method for performing a secure boot procedure in accordance with a number of embodiments of the present disclosure. The method 481 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 481 is performed by the management unit 110 illustrated in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 483, a request can be received from a first sub-system (e.g., the open sub-system 111 and 211 illustrated in FIGS. 1 and 2, respectively) and at a second sub-system (e.g., the secure sub-system 116 and 216 illustrated in FIGS. 1 and 2, respectively) to verify firmware (e.g., the SSBL 226 and 326, secure firmware 224 and 324, and open firmware 222 and 322 illustrated in FIGS. 2 and 3, respectively) to be executed in association with a boot procedure.

At 485, a first signal can be sent to the first sub-system to place the first sub-system into a first state to prevent the first sub-system from further performing the boot procedure. The first signal sent to the first sub-system can set a register (e.g., the register 214 illustrated in FIGS. 2 and 3, respectively) of the first sub-system to a first value to prevent the first sub-system from further performing the boot procedure.

At 487, a second signal can be sent to the second sub-system responsive to verifying the firmware to place the first sub-system into a second state, which allows the first sub-system to execute the firmware. The second signal sent to the first sub-system can set the register of the first sub-system to a second value to allow the first sub-system to further perform the boot procedure. In some embodiments, the second signal can be sent to the first sub-system responsive to the firmware being verified within a particular period of time (indicated by the timer 219 and 319 illustrated in FIGS. 2 and 3). In some embodiments, the boot procedure can be terminated without sending the second signal to the first sub-system responsive to the firmware not being verified within a particular period of time.

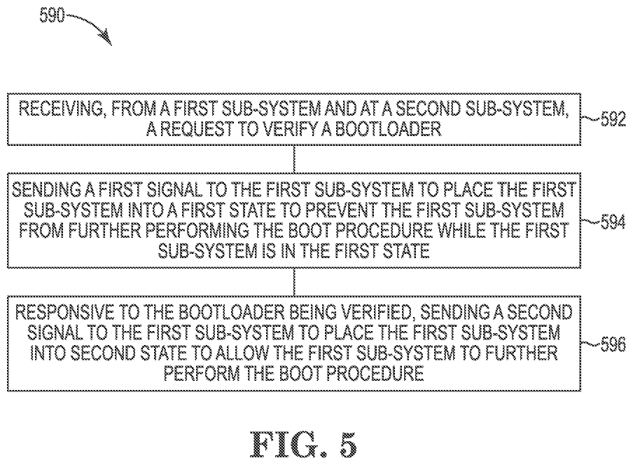

FIG. 5 is a flow diagram of a method for performing a secure boot procedure in accordance with a number of embodiments of the present disclosure. The method 590 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 590 is performed by the management unit 110 illustrated in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 592, a request can be received from a first sub-system (e.g., the open sub-system 111 and 211 illustrated in FIGS. 1 and 2, respectively) and at a second sub-system (e.g., the secure sub-system 116 and 216 illustrated in FIGS. 1 and 2, respectively) to verify a bootloader (e.g., the SSBL 226 and 326 illustrated in FIGS. 2 and 3, respectively). The bootloader can be loaded to the first sub-system responsive to a boot procedure being initiated.

At 594, a first signal can be sent to the first sub-system to place the first sub-system into a first state to prevent the first sub-system from further performing the boot procedure while the first sub-system is in the first state. At 596, a second signal can be sent to the first sub-system responsive to the bootloader being verified to place the boot procedure to a second state to allow the first sub-system to further perform the boot procedure.

In some embodiments, a request can be received from the first sub-system and at the second sub-system to verify secure firmware (e.g., secure firmware 224 and 324 illustrated in FIGS. 2 and 3, respectively) loaded by the bootloader to the second sub-system subsequent to sending the second signal to the first sub-system. Subsequently, a third signal can be sent to the first sub-system to place the first sub-system into the first state to prevent the first sub-system from further performing the boot procedure and executing the bootloader. The secure firmware then can be verified responsive to the request. A fourth signal can be sent to the first sub-system responsive to the secure firmware being verified to place the first sub-system back into the second state to allow the first sub-system to further perform the boot procedure.

Continuing with this example, a timer (e.g., the timer 219 and 319 illustrated in FIGS. 2 and 3) can be reset responsive to the request to verify the secure firmware. As described herein, the timer indicates whether a particular period of time has passed. The fourth signal can be sent to the first sub-system responsive to the secure firmware being verified within the particular period of time.

Continuing with this example, a request can be received (subsequent to sending the fourth signal to the first sub-system) from the first sub-system and at the second sub-system to verify open firmware (e.g., open firmware 222 and 322 illustrated in FIGS. 2 and 3, respectively) loaded by the secure firmware to a shared memory (e.g., the memory 225 illustrated in FIG. 2). A fifth signal can be sent to the first sub-system to place the first sub-system into the first state to prevent the first sub-system from further performing the boot procedure and executing the open firmware. The open firmware then can be verified using (e.g., by executing) the secure firmware. A sixth signal can be sent to the first sub-system responsive to the open firmware being verified to place the first sub-system back into the second state to allow the first sub-system to further perform the boot procedure and execute the open firmware. In some embodiments, the timer can be reset responsive to the request to verify the open firmware and the fourth signal can be sent to the first sub-system responsive to the open firmware being verified within the particular period of time.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, from a first sub-system and at a second sub-system, a request to verify firmware to be executed in association with a boot procedure;
sending a first signal to the first sub-system to place the first sub-system into a first state to prevent the first sub-system from further performing the boot procedure; and
responsive to verifying the firmware, sending a second signal to the first sub-system to place the first sub-system into a second state, which allows the first sub-system to execute the firmware.

2. The method of claim 1, wherein sending the first signal to the first sub-system further comprises setting a register of the first sub-system to a first value to prevent the first sub-system from further performing the boot procedure.

3. The method of claim 1, wherein sending the second signal to the first sub-system further comprises setting a register of the first sub-system to a second value to allow the first sub-system to further perform the boot procedure.

4. The method of claim 1, wherein:
the second sub-system further includes a timer that indicates whether a particular period of time has passed; and
sending the second signal to the first sub-system responsive to the firmware being verified within the particular period of time.

5. The method of claim 1, wherein:
the second sub-system further includes a timer that indicates whether a particular period of time has passed; and
terminating, without sending the second signal to the first sub-system, the boot procedure responsive to the firmware not being verified within the particular period of time.

6. An apparatus, comprising:
a processor; and
a memory coupled to the processor and configured for storing instructions executable by the processor, wherein the instructions, when executed by the processor, cause the processor to, in response to receipt of a request from a first sub-system to verify firmware to be executed during a boot procedure:
set a register of the first sub-system to a first value to prevent the first sub-system from further performing the boot procedure; and
responsive to verifying the firmware, set the register of the first sub-system to a second value to allow the first sub-system to further perform the boot procedure.

7. The apparatus of claim 6, wherein:
the firmware corresponds to a bootloader; and
the instructions, when executed by the processor, cause the processor to, subsequent to setting the register to the second value:
receive, from the first sub-system and at the second sub-system, a request to verify secure firmware loaded by the bootloader to the second sub-system; and
set the register of the first sub-system to the first value again to prevent the first sub-system from further performing the boot procedure and executing the bootloader.

8. The apparatus of claim 7, wherein the instructions, when executed by the processor, cause the processor to further:
verify the secure firmware responsive to the request; and
responsive to the secure firmware being verified, set the register of the first sub-system to the second value to allow the first sub-system to further perform the boot procedure.

9. The apparatus of claim 7, wherein the instructions, when executed by the processor, cause the processor to, subsequent to setting the register of the first sub-system to the second value in response to the secure firmware being verified:
receive, from the first sub-system and at the second sub-system, a request to verify open firmware loaded by the secure firmware to a shared memory accessible by the first and second sub-systems; and
set the register of the first sub-system to the first value again to prevent the first sub-system from further performing the boot procedure and executing the open firmware.

10. The apparatus of claim 9, wherein the instructions, when executed by the processor, cause the processor to further:
verify the open firmware using the secure firmware; and
responsive to the open firmware being verified, set the register of the first sub-system to the second value to allow the first sub-system to further perform the boot procedure and execute the open firmware.

11. The apparatus of claim 6, wherein:
the processor and the memory are part of a second sub-system; and
the second sub-system further includes a timer that indicates whether a particular period of time has passed, wherein the instructions, when executed by the processor, cause the processor to set the register of the first sub-system to allow the first sub-system to further perform the boot procedure responsive to the firmware being verified within the particular period of time.

12. The apparatus of claim 11, wherein the instructions, when executed by the processor, cause the processor to terminate the boot procedure responsive to the firmware not being verified within the particular period of time.

13. The apparatus of claim 11, wherein the instructions, when executed by the processor, cause the processor to reset the timer in response to the register of the first sub-system being set to the first value.

14. A system, comprising:
a first sub-system comprising:
a memory configured for a first bootloader; and
a register; and
a second sub-system communicatively coupled to the first sub-system;
wherein the first sub-system is configured to:
execute, in response to a request to initiate a boot procedure, the first bootloader to load a second bootloader to the first sub-system;
send a request to verify the second bootloader to the second sub-system in response to the second bootloader being loaded to the first sub-system;
wherein the second sub-system is configured to, in response to receipt of the request to verify the second bootloader from the first sub-system:
set the register to a first value to place the first sub-system into a first state to prevent the first sub-system from further performing the boot procedure and executing the second bootloader; and
responsive to verifying the second bootloader, set the register to a second value to place the first sub-system into a second state to allow the first sub-system to further perform the boot procedure and execute the second bootloader.

15. The system of claim 14, wherein the first sub-system is prevented from setting the register.

16. The system of claim 14, wherein the second sub-system is further configured to, subsequent to the register being set to the second value:
receive a request to verify first firmware loaded by the second bootloader to the first sub-system;
set the register to the first value to place the first sub-system into the first state, which prevents the first sub-system from preventing the first sub-system from further performing the boot procedure and executing the second bootloader;
verify the first firmware responsive to the request; and
responsive to the first firmware being verified, set the register to the second value to place the first sub-system back into the second state to allow the first sub-system to further perform the boot procedure and execute the second bootloader.

17. The system of claim 16, wherein:
the second sub-system further comprises a timer that indicates whether a particular period of time has passed; and
the second sub-system is configured to set the register to the second value in response to the first firmware being verified within the particular period of time.

18. The system of claim 16, wherein the second sub-system is further configured to:
receive a request to verify second firmware loaded by the second bootloader to the second sub-system;
set the register to the first value to place the first sub-system into the first state to prevent the first sub-system from further performing the boot procedure and executing the second bootloader;
verify the second firmware responsive to the request; and
responsive to the second firmware being verified, set the register to the second value to place the first sub-system into the second state to allow the first sub-system to further perform the boot procedure and execute the second firmware.

19. The system of claim 18, wherein:
the second sub-system further comprises a timer that indicates whether a particular period of time has passed; and
the second sub-system is configured to set the register to the second value in response to the second firmware being verified within the particular period of time.

20. The system of claim 19, wherein the second sub-system is configured to disable the timer in response to the second firmware being verified.
